(19) United States
(12) Patent Application Publication
(10) Pub. No.: US 2010/0306083 A1
(43) Pub. Date: Dec. 2, 2010

(54) SYSTEMS AND METHODS FOR THE CONFIRMATION OF DOWNLOAD DELIVERY AND ITS USE WITHIN A CLEARINGHOUSE SERVICE

(75) Inventor: Shachar Oren, Atlanta, GA (US)

Correspondence Address: Neurotic Media LLC, Suite 250, 1934-B N. Druid Hills Rd. NE, Atlanta, GA, 30319, US

(73) Assignee: NEUROTIC MEDIA LLC, Atlanta, GA (US)

(21) Appl. No.: 12/787,303

(22) Filed: May 25, 2010

Related U.S. Application Data
(60) Provisional application No. 61/180,958, filed on May 26, 2009.

(51) Int. Cl. G06Q 99/00; G06Q 30/00; G06Q 10/00; G06F 7/00; G06Q 50/00

(52) U.S. Cl. 705/27; 705/30; 705/310; 707/803

(57) ABSTRACT

Systems and methods for the tracking and reporting of the progress, status and completion of the delivery of digital assets, through a network such as the Internet and/or a wireless network, to an end-user device such as a computer or a handheld device, captured by a database that serves as a clearinghouse for multiple parties who are interested in the knowledge provided about the digital asset delivery status and completion. Consequently, the described systems and methods, acting as a centralized clearinghouse of asset delivery transactional data, assist merchants, content owners, and other business stakeholders in determining when the transaction with a consumer is fully complete and associated fees can be exchanged between consumer and merchant as well as between merchant and content owner and other stakeholders. Furthermore, the systems and methods are for management and reporting of the consumer's behavioral trends, inclusive of many data points that can be correlated in order to establish content access credentials, business rules, fees, recommendations, and other parameters that can be put to use by merchants, content owners, and other stakeholders to improve the consumer experience and to offer consumers additional services, including additional entitlement to said digital asset, or a refund for failure to deliver, as the case may be.

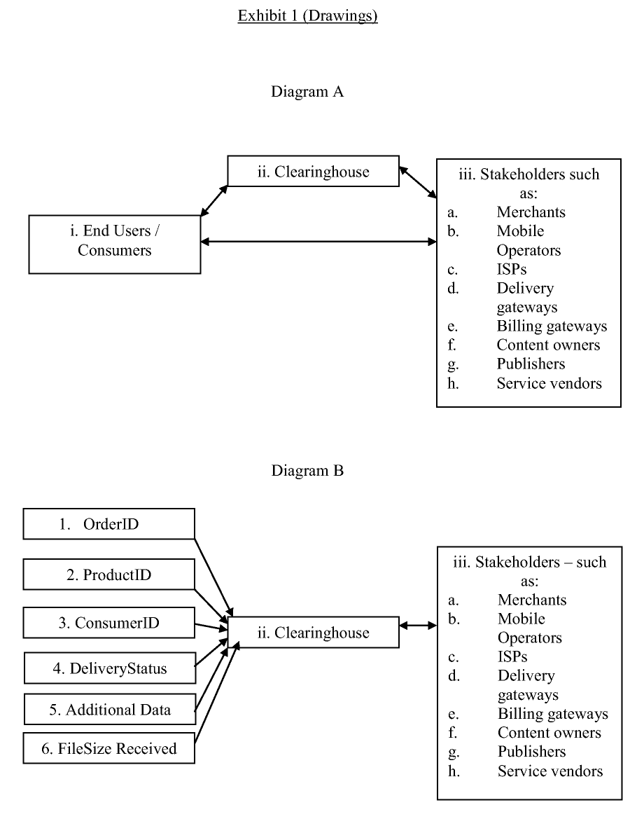

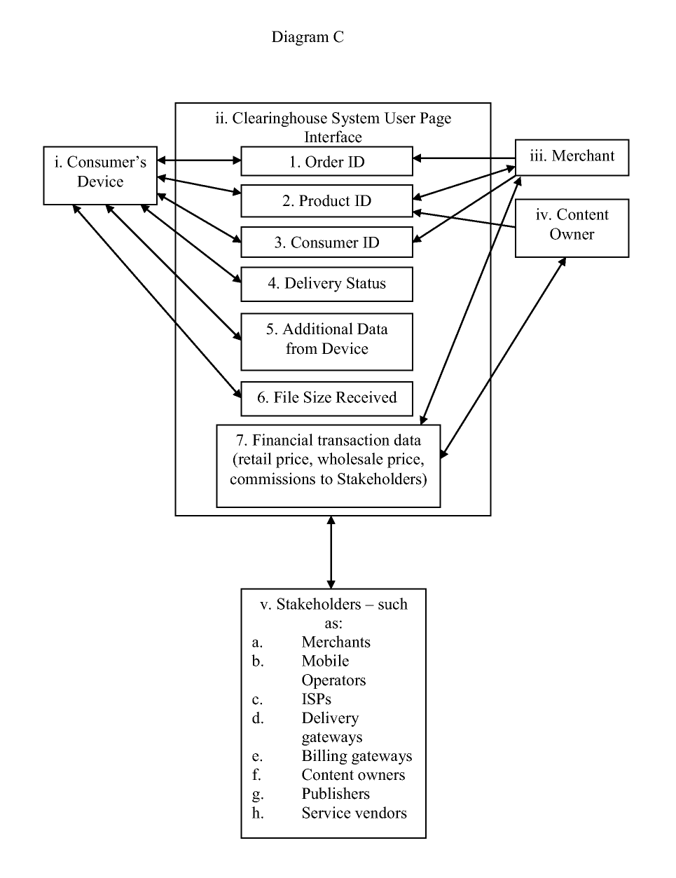

### CROSS-REFERENCE TO RELATED APPLICATION

This application claims the benefit under 35 U.S.C. §119(e) of U.S. Provisional Application No. 61/180,958 filed on May 26, 2009 and entitled “SYSTEMS AND METHODS FOR THE CONFIRMATION OF DOWNLOAD DELIVERY AND ITS USE WITHIN A CLEARINGHOUSE SERVICE,” the subject matter of which is expressly incorporated by reference herein.

### FIELD OF THE INVENTION

The invention generally relates to the field of digital file download delivery confirmation and its tracking by a clearinghouse service used for purposes such as reporting, customer service, and financial purposes, which clearinghouse then provides the tracking data to multiple stakeholders with business interest and entitlement in the digital file download delivery process.

### BACKGROUND

A digital download file is an electronically formatted file that contains digital data. One type of digital file is referred to as a digital asset. A digital asset is an electronic file containing digital data such as audio, video, audio-video, multimedia, music, graphics, a game, an application, or any other type of media-related content, which file may contain specific metadata fields that are descriptive in nature relevant to the specific digital asset's name, creators, owners, size, and other attributes. Digital assets may be stored in a variety of electronic formats. For example, an audio or music file can be stored as a WAV, MP3, AAC, or a WMA-type format, and can represent a product that is sellable either as a one-file asset (an “Item”) or a selection of assets in a folder such as an album, movie, or concert (a “Bundle”). A digital asset can be a promotional file, a salable file, or a downloadable file that a recording company or musical group produces or creates, or that an online retailer or merchant offers, sells, or delivers to a consumer. A digital asset can also be a movie, a game, a smart phone application, or any other type of digital media file now in existence or later created.

Digital assets can be transmitted via a network such as the Internet or a wireless network to a local device, handset or computer, either directly or using intermediary delivery services such as a content delivery network (CDN) that caches the digital asset at the edge network servers before delivery to the consumer, or such as a delivery gateway often used for delivery to the mobile networks of mobile operators which then deliver the digital asset to the consumer device. There are various methods of delivering a digital asset to its eventual residence location, including various HTTP and IP protocols and over-the-air premium and standard SMS protocols.

Typically, the merchant of a digital asset offers, promotes, and/or sells the digital asset to the consumer online via the Internet or via a wireless network. Such a sale and/or delivery offering is normally using a specific client-side application such as a media player, a web browser, an SMS or MMS system, HTTP, or other commonly-used technologies in order to recognize the digital asset on the device and later open it and process it.

This plurality of delivery pathways and methods has created several business challenges in the marketplace, which the present invention aims to resolve. The ability of online merchants to deliver digital assets to consumers may be affected by online connectivity between the merchant's systems and the consumer's computer or handset device, as well as the client-side application used by the consumer and/or its computer or device to administer the digital asset download or streaming process. Furthermore, the merchant's ability to deliver the digital asset to the consumer's handset device or computer may be affected by third parties such as CDNs, mobile SMS gateways, and other parties that provide technical connectivity services and reside between the merchant systems and the consumer's device. Examples of such intermediary services include mobile SMS gateway servers, routers and applications which mobile operators use to connect the consumer's handset devices and cell phones to the Internet, as well as to the mobile operator's in-house systems such as local wireless signal towers, routers and switches, content distribution networks (CDNs) that cache certain digital assets for the merchant closer to the consumer's location (so-called “edge caching”), broadband and ISP providers that maintain internet cables and routers throughout the world, billing mechanisms that meter the bandwidth consumed by the consumer as well as the digital assets sold to the consumer and apply any applicable billing to the consumer's monthly invoice, and so on.

With so many potential dependencies on third party service providers existing between the merchant's systems and the consumer device, the inability of merchants, mobile operators, internet service providers, and other stakeholders in this workflow to guarantee that a digital asset was fully delivered to the consumer's handset or computer creates a significant challenge for the merchant of record and for any other stakeholder in this workflow that is entitled to compensation for its services, and/or to a revenue share in the sale proceeds when a digital asset was sold to the consumer. The plurality and diversity of delivery methods also adds complexity to the ability of the merchant of record and the content owner to have visibility into the completion of their transaction with the consumer, which should then trigger any relevant billing or proceeds calculations for stakeholders. Furthermore, the plurality and diversity of delivery methods creates frustration and distrust with consumers who, without constant and trustworthy service level offering from merchants, mobile operators, ISPs, and other stakeholders, are less inclined to purchase and download digital assets.

At least one system and method has been designed for controlling the delivery and resulting billing in a digital distribution workflow. However, this conventional system relies on encryption and decryption as the method for file delivery verification. Therefore, this conventional system lacks the ability to accommodate files that are not encrypted with a security key (which is the most common form of digital asset delivered to consumers—such as, for example, an MP3 file, an MOV file, or an executable application).

At least one system and method has been designed to track textual data for delivery repair purposes and to track payment made for assumed deliveries. However, this conventional system fails to address the challenges outlined above with respect to an ability to verify a plurality of file format deliveries, through a plurality of delivery pathways and methods, using a plurality of delivery confirmation methods, and report such status in a normalized manner to a central clearinghouse, which in turn serves unlimited number of third party stakeholders who are, in turn, entitled to receive access to the resulting data.

In present systems that do not include a file delivery verification solution, any claim, log, or report by the merchant's system or by any related delivery service that a file was fully delivered to the consumer may be incorrect due to network issues, software issues, and/or technical problems, in general relating to the fact that a plurality of delivery systems exist without a unified solution for measuring their successful delivery of a digital asset in all cases. The lack of proof of delivery means that merchants, mobile operators, and other stakeholders that deliver a file to the consumer or that are billing the consumer for such delivery, have an operational challenge in being able to address consumer complaints about delivery failures, which lead to requests for refunds. As a result, a significant margin of error exists today in the marketplace. This margin of error today causes merchants and vendors significant financial losses due to both issuing refunds in response to consumer complaints, as well as failing to charge for actual successful digital asset deliveries, as the case may be.

For example, a significant percentage of consumers regularly call their mobile operator (also known as “Carrier”), ISPs, or merchants directly to complain that purchased digital assets were not properly received by their handset device or computer, and require support in obtaining the digital asset through re-delivery, or may demand a refund. The mobile operator, ISP, or merchant normally lack proper visibility to the required information in order to be able to truly assess such complaints, because often the party accepting the consumer's call lacks access and visibility into the data of the party that sent the file or sold the file to the consumer. Furthermore, such parties that sell digital assets or help deliver digital assets normally do not track delivery completion in a proper and actionable manner that can be viewed and properly interpreted by any other party. As a result, most stakeholders who are called on by a consumer with a problem tend to issue a refund to the complaining consumer instead of trying to actually resolve the problem, and with no ability to even verify the consumer's claim. This has resulted in significant revenue losses for all stakeholders involved in the sale and/or delivery of digital assets to consumers.

There exists a need for systems and methods to solve these issues on benefit of end users (i.e. consumers) as well as the benefit of other stakeholders, including and not limited to mobile operators, merchants (i.e. retailers), marketers, content owners, and other stakeholders in the ecosystem described herein (collectively referred to henceforth as “Stakeholders”). For example, end users will benefit from improved service quality and reassurance that digital asset deliveries and billing are more accurate; mobile operators, merchants and marketers will benefit from the reduction in requests for refunds, reduction in customer service calls, and ultimately improved profit margins in their business of delivering and/or selling digital assets to end users; and content owners will benefit from the improvement in revenue collection, consumer satisfaction and confidence increase that leads to more sales, and a more accurate and transparent accountability from service providers, merchants, and mobile operators with respect to such sales and such deliveries.

Therefore, there exists a need for systems and methods for digital file download delivery confirmation and its tracking by a centralized clearinghouse data base service used for purposes such as activity reporting, customer care services, and financial reporting purposes by either a single Stakeholder or a plurality of Stakeholders. Furthermore, such a clearinghouse service can provide information that helps the Stakeholders extend further value-add services to end users in order to improve the end user's satisfaction from the digital asset delivery offering. For example, such a system and method may enable a merchant to re-issue a consumer the right to download a digital asset that has failed to be transmitted properly during the previous attempt, or may enable a merchant to improve the software it uses to administer the download process for the consumer on both the server-side and the device client-side. Additionally, such a system and method may enable Stakeholders to have better visibility into successful deliveries in the process of reconciling sales reports and properly sharing in the proceeds of digital asset delivery. Furthermore, such a clearinghouse service can enable the Stakeholders to analyze consumer behavior over time with respect to digital asset delivery that lead to helpful information about trends and preferences which inform Stakeholders' future offering to the consumer and the way by which digital assets are offered, sold, or delivered, and the metrics of file types and content types that are offered to the consumer as digital assets.

At least one system and method has been designed for the verification of digital asset delivery to a media player or a jukebox or other applications on the personal computer or handset. However, such conventional systems and methods offers core technology behind each respective format or function, and fail to disclose how to handle the operational and financial needs of a plurality of Stakeholders who seek to confirm that a transaction between them and the end user involving the delivery of a file has been completed successfully through a plurality of delivery pathways and methods. Due to the plurality of computing devices and handsets and the plurality of operating system software, file format, and networks and delivery pathways in the market today, there are multiple conventional systems for the verification of file delivery completion, none of which alone can fully solve the business challenges of present Stakeholders.

For example, one conventional method uses a file header that is recognized by a client-side application to verify the file was delivered inclusive of all its bits in size, while another conventional method delivers an extra small file after the main file is delivered, using the small file as the delivery completion flag. Yet another existing method uses proprietary encryption software to decrypt a file after its delivery. While such conventional systems and methods have been used for file repair needs by singular merchants or singular delivery services (meaning, if the file has not been fully completed, it can re-initiate delivery from mid-way), such Stakeholders have failed to offer real-time confirmation process between the end user's handset or computer and the plurality of Stakeholders involved in the delivery of digital assets in a manner that informs further action by Stakeholders for the benefit of both Stakeholders and consumers.

Other previous delivery confirmation methods have been solely used to trigger payment for a digital asset, without any regard to a potential need to allow a plurality of Stakeholders to access the data, which may only reside with the server or the party that sold the asset to the consumer. Additionally, such previous system and methods tend to offer a specific methodology that may not accommodate the plurality of devices, operating systems, client software, and delivery networks that exist today in the marketplace.

At least one system and method has been designed to provide media player application companies with a way to extract a portion of the necessary data to report a completion of delivery to a data center from their proprietary media player client application which resides on the handset device or computer. However, no system and method exists that provides a plurality of merchants and service vendors with access to such necessary digital asset delivery confirmation data from a plurality of handsets and computers, irrespective of the existence or absence of any media player, or any other means by which the consumer may elect to obtain and download digital assets from time to time.

Therefore, a need exists for systems and methods for the centralized, accurate and holistic reporting of the completion of the download of a digital asset through a network such as the Internet or a wireless network, in a wide range of electronic file formats, to a wide range of handsets and computers (irrespective of the method of delivery involving a browser, a media player, an application, SMS, MMS, WAP push, or some other delivery-serving application or method) of a plurality of end users, all reporting into a clearinghouse database system which may serve a plurality of Stakeholders with data regarding the completion of the transaction with each respective end user. In the present specification, such a clearinghouse service may track the completion of digital asset delivery using a variety of methods now in existence or later created.

The digital files that are controlled and distributed by the invention may often relate to a fee, a fee description, an e-commerce transaction, a credit, voucher or token value, or another value exchange between a stakeholder and the end user. However, a fee, fee description, or e-commerce transaction is not always required for handling and distribution of digital assets. Therefore, a need exists for systems and methods for tracking the distribution of digital assets unrelated to a fee through a network such as the Internet or a wireless network, while providing Stakeholders with actionable measurability and transparency through a clearinghouse database reporting system which can associate each delivery of each asset with a progress status and/or a success or failure status, as well as associate such delivery with its nature and type, may it be a specific type of a transaction or exchange with the end user, a sponsor, or a free promotional activity. Such a clearinghouse database may then provide various report methods for Stakeholders, such as pull, push, export, real time XML posts, or any other format now in existence or later created, so that data from the clearinghouse can be used by Stakeholders such as customer care personnel, Information Technology quality assurance personnel, and financial department personnel in the course of conducting their respective business and in the course of supporting the end user's needs and expectations with respect to digital asset purchasing and/or reception.

### SUMMARY OF THE INVENTION

The invention addresses the needs described above. The invention provides systems and methods for the reporting of digital asset delivery status and delivery confirmation from the consumer's handset or computer, through a network such as a wireless network or the internet, to a centralized clearinghouse database service or a digital bureau service, which maintains a database of digital assets information coupled with end user's order information and related transactional information, and is able to normalize the data reports (irrespective of the nature of each reporting device, computer, or application, and irrespective of the network workflow between the party delivering the file and the end user device and between the user device and the clearinghouse service) and communicate such data, coupled with additional related product, order, and consumer data, to each of a plurality of relevant Stakeholders in a permission-based manner and in a manner that is actionable for those parties.

The invention provides systems and methods for using such data to deliver reports from the clearinghouse to financial accounting systems, customer care systems (CRM), technical reporting systems, sales and royalty reporting systems, quality assurance systems, mid-tier gateway vendors, and any other system designated by Stakeholders such as merchants, mobile operators, ISPs, payment gateways, content owners, publishers, and other Stakeholders to receive such data, in a manner that supports business rules and decision making rules for such Stakeholders.

Generally described, the systems and methods according to a preferred embodiment of the invention are for the reporting of a digital asset download completion from a plurality of computers or handset devices through a network to a clearinghouse computer system and database that administers consumer rights and entitlements to the digital asset based on pre-set rules provided by a Stakeholder or by Stakeholders; and for the transmission of such information to respective Stakeholders' designated systems for further use.

The invention improves the consumer experience by providing the operational processes by which a merchant, mobile operator, or other Stakeholder can manage the consumer's entitlement to additional download attempts for the same digital asset on the receiving device or computer, or on additional devices or computers, as well as the consumer's entitlement for a refund in the case of a failure to deliver the digital asset successfully. This information can also be used by the relevant Stakeholders to apply a plurality of business rules, practices and policies, as between them and the consumer or as between the Stakeholders themselves. For example, if the consumer is entitled to only one completed copy of a purchased digital asset, and the merchant owes the content owner sale royalty for one completed copy delivered to the consumer, then the system and method described herein allows the merchant to confirm that a completed delivery had occurred in all cases, regardless of which device or which network each consumer uses. If the consumer is entitled to a specific number of copies of the digital asset on a specific number of devices or computers, then the present invention provides the merchant with the ability to accurately administer such download rights, acting on the accuracy of the data provided from the consumer device or computer and stored in and reported by the centralized clearinghouse database.

The clearinghouse that administers the delivery completion reports that are incoming from the consumer computers and handset devices can therefore serve a plurality of Stakeholders throughout the digital product marketplace with actionable information for, to name a few, financial personnel, customer service personnel, and technical support personnel. More particularly described, the systems allow Stakeholder's technical teams to be informed of the progress, failure, or completion of the digital asset delivery to the consumer's computer or handset device, using computerized networks such as the Internet, a telecom network, a wireless network, or other similar systems, to return a token or flag component to the clearinghouse and onto the delivering party's systems, which associate the completed delivery with a specific digital asset order recorded and served by a Stakeholder.

For the clearinghouse to be able to conduct the service outlined above, its administration capabilities may be enabled by the following: (i) the distribution of an executable software application, or a variety of software applications, to computers and handset devices that send needed information, in the form of a flag or token transmission, from the computer or handset to the clearinghouse over the internet or wireless network to report asset delivery status, and/or (ii) the provisioning of a method by which third party applications, including server-side applications and/or third party media players and download management applications can send information from the computer or handset device to the clearinghouse, (iii) the identification of the digital asset by the said executable application or third party application on the computer or handset device, including the ability to track download process and download completion status, (iv) the transmission of said data over the network and the entry of said information related to the digital asset download progress and completion into the clearinghouse database for storage in a fashion that is uniquely conducive for efficient administration of the information and its distribution to related Stakeholders, (v) the matching of product, order, and consumer data in the clearinghouse, as provided by specific Stakeholders, with the completion report from the Device about a specific digital asset delivery to a specific customer, (vi) the further transmission of said information, in a normalized, formatted (meaning, a reporting format that displays all items in a similar fashion regardless of which Device reported activity over which network), or enhanced manner, from the clearinghouse, though a network such as the Internet or a wireless network, to Stakeholders that are entitled to such information, and (vii) the ongoing monitoring and analysis, by Stakeholders, of activity related to the digital asset, the consumer, and any other related data available within the clearinghouse database, throughout the digital asset distribution life cycle, and the generation of analysis data from the clearinghouse system that supports the business needs of the various Stakeholders.

### BRIEF DESCRIPTION OF THE DRAWINGS

Exhibit 1 is a description of an exemplary embodiment of a system and method in accordance with the invention.

Diagram A is a block diagram of a computing environment in which the present invention functions according to one embodiment of the present invention.

Diagram B is a block diagram of a computing environment in which the present invention functions according to one embodiment of the present invention, detailing certain optional fields that may be reported by the device, or otherwise captured by the system about the device and the consumer, with respect to a digital asset delivery.

Diagram C is a block diagram of an administrative screen environment in which the present invention functions according to one embodiment of the present invention, allowing a stakeholder's user to interact with specific data captured from both the end user device and multiple Stakeholders, and then matched by the clearinghouse database service in order to provide a unified screen where the administrative user can review the data in the context of a specific order, consumer, or product.

### DESCRIPTION OF DISCLOSED EMBODIMENTS

Systems and methods according to an embodiment of the invention provide for the tracking and reporting of the progress status and completion status of the delivery of digital assets, through a network such as the Internet and/or a wireless network, to an end device such as a computer or a handheld device, transmitted onto a database that serves as a clearinghouse for multiple parties who are invested in the knowledge-base provided by the clearinghouse about said digital asset delivery status. The systems and methods are for providing actionable information about download completion that serve Stakeholders in determining when the transaction with a consumer is fully complete and any associated sales fees or proceeds can be exchanged between consumer and merchant as well as between various Stakeholders involved in the delivery of the said digital asset. Further, the systems and methods are for the handling of customer service issues such as re-issuance of download rights to the consumer, or refund requests handled by merchants, carriers, ISPs, and other vendors who play a role in delivering a digital asset to the consumer and/or in administering customer service to the consumer, including, if applicable, the issuance of refunds, or the issuance of additional entitlements to download said digital assets on the same device or computer or on additional device(s) and computer(s). Additionally, the systems and methods are for management and reporting of data about the consumer's behavioral trends, inclusive of device, computer, network, carrier, ISP, merchant, or any other related data point that can be correlated in whole or in part by clearinghouse users such as the merchants or the content owners, in order to establish content access credentials, business rules, fees, recommendations, and other parameters that can be put to use by Stakeholders to improve the consumer experience and to offer consumers additional services.

As described in this specification, a “Consumer” or “End User” is the person or persons receiving a digital asset delivery to a personal computer or a handset or mobile device; a “Clearinghouse” is a centralized database system which offers a service to Stakeholders by tracking digital asset delivery status and completion and reporting such data, coupled with other actionable data about the transaction and delivery of the asset, to Stakeholders; and “Stakeholders” are various parties that have a financial or otherwise business interest or entitlement to access data from the Clearinghouse about a specific delivery of a digital asset to said end user; such Stakeholders may include “Merchants”, who are the retail brands who sell the digital asset to the consumer; Mobile Operators, who may act as Merchants, or as delivery and billing gateways, or in some cases simply facilitate the technicality of the asset delivery over their systems to the end user device; “ISPs” are Internet service providers, who may act as Merchants, or as delivery and billing gateways, or in some cases simply facilitate the technicality of the asset delivery over their systems to the end user device; “Delivery Gateways” are technical vendors who provide access to a third party network, such as a gateway provisioning over-the-air deliveries to mobile carriers; “Billing Gateways” are service providers focusing on transaction processing such as e-commerce, m-commerce, premium SMS and other forms of electronic transaction and other transaction mechanisms; “Content Owner” is an entity that provides digital assets such as media files, downloads, streams, song downloads album downloads, games, videos, mobile applications, and other digital products and promotions to merchants and to consumers, and can impose specific user limitations on the consumption of its digital assets such as the number of copies deliverable to a consumer per payable order, and/or per device or computer owned by the consumer, and/or the types of distribution allowed, and/or the digital asset file type and quality, among others; “Publishers” are content ownership royalty administrators who act on behalf of the content creators to collect specific publishing fees from merchants and other Stakeholders; “Service Providers” are third parties that provide services to specific “Stakeholders”, such as, for example, Customer Service specialists, marketing data analysis specialists, and content distribution network (CDN) services.

Exhibit 1 is a description of an exemplary embodiment of a system and method in accordance with the invention. It includes Diagram A, Diagram B and Diagram C.

Diagram A illustrates the relationship between the Consumers (A.i), the Clearinghouse (A.ii.), and the Stakeholders (A.iii). It illustrates that Stakeholders may submit data about digital assets into the Clearinghouse which facilitate the tracking activity and reporting capabilities of the clearinghouse, which in turn communicates with Consumer's devices and reports back to Stakeholders accordingly. This illustrates the clearinghouse's role as intermediary for information exchanged between Stakeholders and consumers, irrespective of the digital asset delivery itself being conducted by the clearinghouse or by a Stakeholder.

As it relates to the invention as illustrated in Diagram A, the clearinghouse itself may represent a merchant or merchants. Content owners may also represent merchants, as may mobile operators or other parties. A clearinghouse in general may be an independent or third party service, or it may be a service offered by any existing Stakeholder in the ecosystem. The clearinghouse may serve a plurality of Stakeholders and consumers.

Diagram B is a description of an exemplary platform architecture in accordance with the invention. In this diagram, architecture is described with the various associations that can be made between the Stakeholders, the data clearinghouse, and the client-side utility that delivers the download status report to the warehouse, further to Diagram A.

Diagram B illustrates the consumer device's relationship with the clearinghouse (B.ii) and the Stakeholders (B.iii), as the case may be. Depending on each implementation of the invention, the embodiment of the invention may only use a part of these relationships, or all of these relationships. For example, the consumer may never interact directly with the content owner (B.iii.f), or with the merchant (B.iii.a), or with the clearinghouse (B.ii), but rather just with one of the three, or with two of the three.

Furthermore, Diagram B illustrates the consumer device's supplied data fields broadly (B.1 through B.6), which is representative of the consumers' receptacle devices data reply to the clearinghouse when reporting the status of digital asset delivery. The consumer connects to both the clearinghouse and any of the Stakeholders via a Network, such as a wireless network or the Internet.

The Clearinghouse database contains information about each respective Stakeholder and related digital assets, inclusive of a plurality of parameters, business rules, prices and fees, and digital asset parameters such as product IDs, file formats and sizes, and any other information provided about a digital asset by a Stakeholder who seek to use the clearinghouse' services.

In one embodiment of the invention, the consumer device, such as a wireless device or a computer, may contain a software application, or the consumer may download and install such application, which is prepared and provided by the clearinghouse or a Stakeholder using the clearinghouse. The application is able to capture data from the digital asset downloaded by the consumer, either after the download has completed or during the delivery process of the digital asset, which it is then able to transmit back to the clearinghouse together with additional parameters, as illustrated in Diagram B, over the said network. In the example shown in Diagram B, the end user device passes to the clearinghouse data points such as OrderID (B.1.), ProductID (B.2.), and ConsumerID (B.3.)—each ID representing a unique identifier (number or other parameter) about the consumer, the order placed, and the product in that order, respectively; coupled with additional related data such as the delivery status (B.4.) (such as Complete vs. Non-Complete or In Progress), File Size Received (B.6), (such as file size in bits, which the Clearinghouse may match with existing records and use for delivery verification), and additional pertinent data (B.5.) about delivery completion and/or about the order and the consumer.

In another embodiment of the invention, the clearinghouse may receive the download status information from the consumer's computer or device via a server-side application such as Java Run Time or Flash applications, or from a third-party media player or jukebox, together with additional parameters, as illustrated below in Diagram B, by enabling such third party application to post such information into the clearinghouse using pre-agreed data posting methods or data pulling methods.

In another embodiment of the invention, such delivery status may simply contain a flag or token field that indicates that the delivery is complete. In yet another embodiment of the invention, such delivery status may involve a percentage of delivery as determined by the client-side application by comparing the size of the file as registered in the clearinghouse to the size of the file delivered to the device or the computer, in bytes or another measurement unit. In yet another embodiment of the invention, such delivery status may involve a transmission of bytes received by the end-user device, allowing the clearinghouse to calculate the percentage delivered and make the determination if the delivery is complete or not.

In an additional embodiment of the invention, a small header file is delivered with the digital asset to the device in a configuration that forces the header file to be the last component delivered by a merchant, CDN, or the clearinghouse to the device or computer, in a manner that may contain some of the said fields in such a header or a flag; which then allows the application on the device or the computer to identify that the delivery was complete, and report the delivery as complete to the clearinghouse, or transmit the flag or header component back to the clearinghouse as a proof of delivery token. A delivery confirmation file or token may be a simple text file, a file header GUID, an XML file, or any other type of file, encrypted or simple, that meets the requirements set by the merchant, content owner, clearinghouse, ISP, carrier, and/or specific device or computer.

In yet another embodiment of the invention, a third party digital rights management (DRM) may be used, whereby the digital asset may be encrypted and require a decryption key, or license, in order to open and execute/play on the consumer device or computer, and the clearinghouse may use the call made by the device or computer to the clearinghouse for a DRM license key as proof of delivery completion.

As exemplified in these specifications, the reporting of digital asset delivery status and completion status can be done in various ways now in existence or later created, each deciphered by the clearinghouse in accordance with the plurality of devices, operating systems, and networks in the marketplace.

Diagram B also illustrates that, in another embodiment of the invention, additional information can be attached to the response from the device or the computer which provides the download delivery status to the clearinghouse. Such additional data (B.5.) may include device-specific information such as device User Agent, device ID, device chip ID, or other identifiable parameters about the device, or about the consumer. In another embodiment of the invention, such additional information may include voluntary data submission by the consumer to the clearinghouse such as device registration, or login credentials to specific services, stores, networks, or devices. In another embodiment of the invention, such additional information may contain information about digital assets that did not originate with the said clearinghouse, and which were identified by the application and their basic available information transmitted to the clearinghouse. The clearinghouse may share such information with merchants and content owners, as well as use some information for behavioral analysis and provide consumer with data about such digital assets, recommendations, or other services and benefits.

Diagram B shows the clearinghouse (B.ii.) as the database that aggregates the data transmitted to it by the consumer devices or computers (B 1 through B 6). The clearinghouse may then transmit elaborate reports to Stakeholders (B.iii). Such reports may contain any or all data collected from the consumer device or computer, coupled with any additional information associated with those IDs and parameters in the clearinghouse database.

The exchange of information among consumer devices and computers, the clearinghouse, merchants, and content owners, may take place over a network such as the internet or wireless network, and put to use commonly used protocols such as XML SOAP, HTTP Get, HTTP Post, and other Web services and push/pull technologies that are in common use and allow parties to exchange information securely over a network. The database itself can be designed using any one or variety of available database technologies. The client-side application provided by the clearinghouse service to merchants, carriers, handset and computer manufacturers, and consumers, which is responsible for tracking and reporting download completion to the clearinghouse, may be designed using a variety of technologies, each version suited for the specific requirements of a specific device, computer, network, or merchant, as the case may be.

Diagram C is a description of an exemplary embodiment of a method in accordance with the invention, which shows how the data administered by the Clearinghouse (C.ii) may be provided on a screen accessible by certain Stakeholders personnel (C.v.) in order to administer certain data functions related to consumer entitlement, rights, and service support, as well as merchant's billing and/or content owner's sales proceeds, as examples. Diagram C illustrates (C.ii) which data fields are provided by a merchant (C.iii) (may that be a retailer, mobile operator, content owner, a brand, a service provider, or another Stakeholder) or a content owner (C.iv.), and which fields represent correspondence between the consumer device (C.i.) and the clearinghouse system (C.ii, 1 thru 6). As an example of one embodiment of the invention, the diagram illustrates how actionable data may be collected from the Consumer Device (C.i.) and fed back to the Clearinghouse System (C.ii). As previously mentioned, this can be achieved in a variety of manners now in existence or later created, including but not limited to push and pull technologies, measurement of file size in bits or bytes as delivered to the device, a header file or delivery completion flag file accompanying the main file, and other methods; this process may also involve a software application or utility on the Consumer Device that is programmed to leverage one or a few such indicators of file delivery status or completion algorithms and communicate the status in real time, or in pre-designated intervals or schedules, to the Clearinghouse.

In one embodiment of the present invention, such communication from Consumer Device (C.i.) to Clearinghouse (C.ii.) may include OrderID (C.ii.1), ProductID (C.ii.2), ConsumerID (C.ii.3), delivery status such as Yes/No completion status or percentage of file size completion status or total file size in bits or bytes (C.ii.4), and additional data (C.ii.5) about the device itself such as User Agent, make and model, or number, which may help a customer care representative from any specific Stakeholder analyze the status of the order. For the sake of clarification, file-specific parameters such as OrderID, ProductID, Consumer ID, and file size, to name a few, would have been transmitted to the device by either the Clearinghouse or a Stakeholder previous to, during, or shortly after the delivery of the asset to the consumer device, in order to allow the device to associate the asset with such data and be able to place a report back to the Clearinghouse using any suitable method configured for it. As described in this specification, Order ID is the unique identifier of the Order, Product ID is the unique identifier of the Product, and Consumer ID is the unique identifier of the consumer, whereby each such identifier can be made of alpha-numeric string of random characters or intentionally composed characters in order to create a unique identifying number set. As further shown in Diagram C, a Merchant (C.iii) (such as a retailer, content owner, mobile operator, service provider, or other Stakeholders serving as Merchants) provide the Clearinghouse (C.ii) with Order ID, Product ID, and Consumer ID, as basic parameters which, in one embodiment of the present invention, are the basics data fields used by the Clearinghouse system to identify, track and report on a particular transaction and asset delivery completion across the ecosystem. Furthermore, Diagram C shows how in the said embodiment of the invention, a user on any Stakeholder's side (C.v.) may have access to such data as it is entitled to enter in its unique role, within the Clearinghouse via a reporting admin or system, which then help such a user administer business operations as between the merchant, content owner, any other stakeholder, and consumer. For example, such a user of the data may realize if payment should have been charged to the consumer, or if the consumer should be re-issued the right to download the asset if, for example, the billing was processed in error while the delivery did not yet complete properly—both examples representing common problems in the industry which the present invention aims to resolve.

As described in this specification, a “Content Owner” is an entity that provides new digital assets such as media files, downloads, and promotions. The Content Owner can impose specific user limitations on the content of its digital assets such as the duration of play, number of plays, types of distribution, and quality—as well as establish wholesale cost, suggest retail price, or offer sale commission to a merchant.

As described in this specification, a “Publisher” is an entity that controls certain rights in digital assets such as media files, downloads, and promotions, including but not limited to, receiving certain financial compensation for the use and/or sale of such assets by Merchants.

As described in this specification, a “Merchant” is an entity that sells the asset to the consumer (end user) via a retail site or store, either online or via a mobile device. The Merchant can be a traditional retailer, non-traditional retailer, a consumer brand offering product or services, as well as a mobile operator, service provider, content owner, or any other entity acting as so-call “merchant of record” and transacting with the consumer, for money or exchange of other value or benefits, for the delivery of the digital asset to the consumer. The Merchant can decide what digital assets to sell, when, and for how much.

As described in this specification, a “Mobile Operator” is a carrier, MVNO, or another mobile services company offering a variety of mobile connectivity services to the consumer. The Mobile Operator can impose specific user limitations on the content of its digital assets such as the duration of availability, pricing, or collecting service fees, delivery charges, or transactional service charges from the consumer and/or from any other Stakeholder using its systems.

As described in this specification, an “ISP” is an internet service provider offering a variety of internet connectivity services to the consumer. The ISP can impose specific user limitations on the content of its digital assets such as the duration of availability, pricing, or collecting service fees, delivery charges, or transactional service charges from the consumer and/or from any other Stakeholder using its systems.

As described in this specification, a “Delivery Gateway” is technology service provider offering a file delivery connectivity services to Stakeholder to help deliver assets to the consumer's Devices. The Delivery Gateway can impose specific user limitations on the content of its digital assets such as collecting service fees, delivery charges, or transactional service charges from the consumer and/or from any other Stakeholder using its systems.

As described in this specification, a “Billing Gateway” is technology service provider offering a file delivery connectivity services to Stakeholder to help bill the consumer for the asset delivered. The Billing Gateway can impose specific user limitations on the content of its digital assets such as collecting service fees, delivery charges, or transactional service charges from the consumer and/or from any other Stakeholder using its systems.

As described in this specification, a “Service Vendor” is technology service provider offering any auxiliary services to Stakeholder to help deliver assets to the consumer's Devices, or offering service to the consumer to improve the consumer's experience with respect to asset delivery. The Service Vendor can impose specific user limitations on the content of its digital assets such as collecting service fees, delivery charges, or transactional service charges from the consumer and/or from any other Stakeholder using its systems.

As described in this specification, a “Clearinghouse” is the systems and database which aggregate transactional data between the various Stakeholders and a plurality of Consumers about a plurality of digital assets, and which provides data to Stakeholders to help their personnel monitor and improve their asset delivery services and the validation of related transactions. A Clearinghouse may be an independent party, or may be a part of one of the Stakeholders, or operated by a consortium of Stakeholders, as the case may be.

Furthermore, the systems and methods are for management and reporting of the consumer's behavioral trends, inclusive of many data points that can be correlated in order to establish content access credentials, business rules, fees, recommendations, and other parameters that can be put to use by merchants, content owners, and other stakeholders to improve the consumer experience and to offer consumers additional services, including additional entitlement to said digital asset, or a refund for failure to deliver, as the case may be. For example, the “User Agent” (which is a unique identifier of a particular make, model, and operating system configuration of a device) of the consumer's device may be used by the clearinghouse to inform Stakeholders of the need to upgrade the device's software in order to improve the ability to track the completion of an asset download, or to make recommendations about similar products to the consumer based on the assets it has thus chosen to transact for and download.

As previously described, each Stakeholder identified in Diagram C may have multiple business reasons to access relevant data to each transaction relevant to their business, including but not limited to data about the financial transaction with the consumer, the division of proceeds across multiple Stakeholders involved in such transaction, customer service support provisioning, quality assurance measurement analysis, and other business measurements which inform each respective Stakeholder's work on behalf of itself, other Stakeholders, and the consumer.

What is claimed is:

1) A method for the tracking and reporting of the delivery status of digital assets, through one or more networks such as the Internet or a wireless network, onto a plurality of end users' computers and mobile devices, which provides for said digital assets' delivery status and attributes to be stored, monitored, and reported by a centralized database clearinghouse service to a plurality of parties who are stakeholders in the asset delivery process and who use such data for service provisioning and for business decision making, said method comprising:
a) creating a data base of media assets in a plurality of formats, coupled with a plurality of client-side methods of obtaining digital asset delivery status from consumer devices into the said data base;
b) organizing said data base by orders, consumers, and products, whereas each product is associated with a digital asset in said data base using selected attributes of said digital asset other than the format of the asset, and whereas such data can be associated with digital asset delivery to consumer devices;
c) subject to and responsive to communication from each said consumer device about the status of each digital asset delivery to the device, creating a data base record of the status of the delivery of the digital asset, including such acceptable parameters such as digital asset size, pricing, delivery progress stage, delivery completion, device user agent parameters, and other product provisions, consumer data, and device data;
d) responsive to a communication by an authorized stakeholder, transmitting said data from the clearinghouse data base to said stakeholder in formats acceptable to the stakeholder; and
e) allowing the stakeholder to review said data in or from the clearinghouse data base that allows such stakeholder to make business decisions about the digital asset transaction.

2) The method of claim 1 wherein a selected stakeholder is a content owner.

3) The method of claim 1 wherein a selected stakeholder is a merchant.

4) The method of claim 1 wherein a selected stakeholder is a mobile carrier.

5) The method of claim 1 wherein a selected stakeholder is a publisher.

6) The method of claim 1 wherein a selected stakeholder is an ISP.

7) The method of claim 1 wherein a selected stakeholder is a service vendor.

8) The method of claim 1 wherein a selected stakeholder is a billing gateway.

9) The method of claim 1 wherein a selected stakeholder is a delivery gateway.

10) The method of claim 1 wherein the clearinghouse database is also a selected stakeholder.

11) The method of claim 1 wherein a selected attribute is the product metadata and identifying parameters.

12) The method of claim 1 wherein a selected attribute is the order data and identifying parameters.

13) The method of claim 1 wherein a selected attribute is the consumer data and identifying parameters.

14) The method of claim 1 wherein a selected attribute is the consumer computer or mobile device data and identifying parameters.

15) The method of claim 1 wherein a selected attribute is the digital asset metadata and identifying parameters.

16) The method of claim 1 wherein a selected attribute is the order's financial transaction data and related parameters.

17) The method of claim 1 wherein a selected attribute is the portion of data selectively attributed to one selected stakeholder.

18) The method of claim 1 wherein the clearinghouse data base service is also the stakeholder sending the actual digital asset to the consumer's device.

19) The method of claim 1 wherein the clearinghouse data base service receives transactional data from the stakeholder who is the merchant of record in the form of a report about digital asset(s) delivered by such merchant to consumers, and wherein said merchant invites the clearinghouse to track status of and report on the status of said digital asset deliveries to specific stakeholders in the digital asset delivery status.
